(19) United States
(12) Patent Application Publication
(10) Pub. No.: US 2012/0252963 A1
(43) Pub. Date: Oct. 4, 2012

(54) POWDER COATING METHOD

(75) Inventor: Peter Minko, Schwelm (DE)

(73) Assignee: E I DU POONT DE NEMOURS AND COMPANY, Wilmington, DE (US)

(21) Appl. No.: 13/515,297

(22) PCT Filed: Dec. 13, 2010
(86) PCT No.: PCT/US10/60038

§ 371 Date: Jun. 12, 2012

Related U.S. Application Data
(60) Provisional application No. 61/286,047, filed on Dec. 14, 2009.

(51) Int. Cl. B05D 7/00; C08L 33/00; B05D 3/12; C09D 167/00

(52) U.S. Cl. 524/556; 524/599; 427/560

(57) ABSTRACT

The invention relates to a powder coating method comprising the following steps:
a) applying particles of a powder coating composition the particles having a number average particle size in the range of 1 to 300 μm onto a substrate surface, wherein the number average particle size is based on D90 value determined according to ISO 13320-1,
b) vibrating the particles on the substrate surface at near-ambient temperature or increased temperature with at least one vibrator device providing a frequency of the vibrations in a range of 10 to 1000 Hz and a given vibration power, during and/or after the applying, and
c) processing the vibrated particles to a cured coating on the substrate surface.

The method according to the invention makes it possible to provide coatings with highly improved appearance after curing, particularly, improved thickness performance of the coating layer, uniform distribution of the powder particles on the substrate surface and improved flow of the boating.

### FIELD OF THE INVENTION

The invention relates to a powder coating method providing a high performed appearance of the coating on the substrate surface.

### DESCRIPTION OF RELATED ART

Powder coating compositions may be typically applied to metallic and non-metallic substrates by electrostatic forces whereby non-metallic substrates can be pre-treated, for example, with conductive primers, by pre-heating with microwaves or exposing the substrate to dry heat prior to the application of the powder coating composition to provide sufficient conductivity. Powder coating compositions may be applied by, e.g., electrostatic spraying, electrostatic brushing, thermal or flame spraying, fluidized bed coating methods, flocking, tribostatic spray applications and the like, all of which are known to those skilled in the art. After being applied, the coating can be melted and cured by methods known in the art. Fluidized bed coating methods may be used, for example, under whirling up the powder particles in the powder feed dosator with the help of air and under shaking the powder feed dosator to avoid agglomeration of the powder particles.

The cured coatings may have, however, un-sufficient appearance, visible with the naked eye, due to un-sufficient performed coating process. Therefore such coatings are not acceptable due to aesthetic and/or utility related reasons. Such kinds of faults on the cured coatings can be eliminated only under high cost and immense work load.

JP-A 7195026 discloses an improvement of corrosion resistance, smoothness and mechanical strength by vibrating a mixture comprising a substrate having an adhesive layer, a powder containing fibrous material and a film forming medium to form a fiber-reinforced powder coating on the substrate. However, an aggregation of the powders by heat-treating is necessary.

It is known to use ultrasound commonly with a frequence in a range of 20,000 Hz to 1 GHz to provide a shaking of particularly fine particles, to remove them from a substrate for cleaning reasons.

Therefore, there is a need to provide a simple method of powder coating to overcome the disadvantages of the prior art with regard to powder coating processes.

### SUMMARY OF THE INVENTION

The invention relates to a powder coating method comprising the following steps:
a) applying particles of a powder coating composition the particles having a, number average particle size in the range of 1 to 300 μm onto a substrate surface, wherein the number average. particle size is based on D90 value determined according to ISO 13320-1,
b) vibrating the particles on the substrate surface at near-ambient temperature or increased temperature with at least one vibrator device providing a frequency of the vibrations in a range of 10 to 1000 Hz and a given vibration power, during and/or after the applying, and
c) processing the vibrated particles to a cured coating on the substrate surface.

The method according to the invention makes it possible to provide coatings with highly improved appearance after curing, particularly, improved thickness performance of the coating layer, uniform distribution of the powder particles on the substrate surface and improved flow of the coating. Additionally, the occlusion of air can be decreased and, therefore a coated surface can be provided with no faults of the cured coating. Further, the technological properties of the cured coating, such as, abrasion, scratch and scuff resistance, leveling, outdoor stability, chemical resistance and hardness remain at the original desired level.

### DETAILED DESCRIPTION OF THE INVENTION

The features and advantages of the present invention will be more readily understood, by those of ordinary skill in the art, from reading the following detailed description. It is to be appreciated those certain features of the invention, which are, for clarity, described above and below in the context of separate embodiments, may also be provided in combination in a single embodiment. Conversely, various features of the invention that are, for brevity, described in the context of a single embodiment, may also be provided separately or in any sub-combination. In addition, references in the singular may also include the plural (for example, “a” and “an” may refer to one, or one or more) unless the context specifically states otherwise. Slight variations above and below the stated ranges of numerical values can be used to achieve substantially the same results as values within the ranges. Also, the disclosure of these ranges is intended as a continuous range including every value between the minimum and maximum values.

All patents, patent applications and publications referred to herein are incorporated by reference in their entirety.

The present invention is based upon the method wherein the particles of a powder coating composition are vibrated during and/or after applying onto a substrate surface prior to the curing of the coating. The vibrating may be done at near-ambient temperature or increased temperature.

In step a) of the method according to the invention the particles of a powder coating composition are provided and applied onto a substrate surface. This can be done by several techniques as known in the art, e.g. at near-ambient temperature or increased temperature, by electrostatic spraying, electrostatic brushing, thermal or flame spraying, or fluidized bed coating methods, flocking and/or tribostatic spray applications. The powder can be applied by a powder feed dosator as known in the art, for example, continuous powder feed-dosator.

According to step b) of the method according to the invention the powder particles are vibrated, during and/or after applying, with at least one vibrator device providing a frequency of the vibrations in a range of 10 to 1000 Hz. Preferred is a frequency in a range of 10 to 100 Hz.

The vibrating process of step b) is proceeded with a vibration device providing a vibration power to the powder particles in a range of, for example, 0.5 KN (Kilo Newton) to 60 KN, dependent from kind and size of the substrate surface to be coated. For example, the vibration power can be in a range of, for example, 40 KN to 60 KN, for larger substrate surfaces, for example, of car bodies. The vibration power can be in a range of, for example, 0.5 KN to 40 KN, for smaller substrate surfaces, for example, of industrial goods. The vibration power can be regulated and controlled by methods known in the art, for example, by frequency transforming.

The term vibration power stated in the present description is determined by the centrifugal force of the vibration device and can be described in terms of vibration mass, number of revolutions and acceleration, known, as such, to a person skilled in the art.

The vibrating step b) may be proceeded within a time period in a range of 1 to 300 seconds, preferred 5 to 100 seconds. This can be done as a one-time step, e.g. continuously, or discontinuously in several times, within the time period as mentioned above.

The vibrating step b) may be proceeded at near-ambient temperature or at increased temperature. Near-ambient temperature means the temperature of the surrounding area of the substrate during applying and/or vibrating according to the invention, for example, spray cabin, in a range of, for example, 10 to 25° C., at ambient pressure which means atmospheric pressure, as known in general, in a range of, for example, 900 to 1050 mbar. Increased temperature means the temperature of the surrounding area of the substrate during applying and/or vibrating according to the invention, for example, spray cabin, in a range of 28° C. to a temperature where the particles just start to soften or melt, for example, in a range of 30 to 100° C., preferably 30 to 60° C. The upper value of such increased temperature depends from the kind of the powder particles and is below the glass transition temperature (Tg) in case of amorphous and/or semi-amorphous powder particles or below the melting temperature (Tm) in case of crystalline and/or semi-crystalline powder coating particles. The upper value of such increased temperature can therefore be 1 to 10° C. below Tg and/or Tm, preferably 5° C. below Tg and/or Tm.

The term Tg stated in the present description is the glass transition temperature of the solid component(s) measured by means of differential scanning calorimetry (DSC) according to ISO 11357-2.

The term Tm stated in the present description is the, melting temperature of the solid component(s) measured by means of DSC at heating rates of 10 K/min according to DIN 53765-B-10.

The at least one vibration device can be well known devices which are suitable for installation in the powder coating process. For example, well known vibration motors can be used, in all kind of performances, for example, vibration tables, vibration conveyor belts, vibration suspensions, or combinations thereof. The vibration motor can be used as indirect vibration source using such performances, but the vibration motor can also be directly combined with the substrate to be coated.

All kinds of vibration can be used for the method according to the invention. For example, possible are two-dimensional and/or three-dimensional vibrations, for example, in one direction and/or as circular vibration, and they can have different shape, for example, sinus, rectangular and/or saw tooth shape, generated by methods known in the art.

In step c) of the method according to the invention the vibrated powder particles are processed to a cured coating on the substrate surface. For that the powder particles can be at first molten (fused and flowed out) by increased temperature. This can be done by exposing the particles to thermal energy, e.g., by IR-radiation, IR-radiation combined with hot-air convection, or hot-air convection. IR radiation includes also Near-Infrared radiation (NIR). Typically IR radiation uses wavelengths in the range of 0.76 μm to 1 mm and NIR radiation used wavelengths in the range of 0.76 to 1.2 μm. The temperature for such melting may be, for example, in the range of 60 to 250° C., measured as substrate surface temperature, dependent from the kind of the powder particles as described above.

The molten powder is then cured. This can be done, for example, by high-energy radiation with a UV doses in a range of, for example, 100 to 5000 mJ/cm² as known in the art. It is also possible to exposing the molten powder to thermal energy with methods as described above. The molten powder may, for example, be exposed by convective and/or radiant heating to temperatures of approximately 60 to 250° C., preferably of 80 to 160° C., measured as substrate surface temperature and dependent from the kind of the powder particles as described above. Exposing to thermal energy before, during and/or after irradiation with high-energy radiation is also possible.

The coatings may be applied to metallic and/or non-metallic substrates, and can be applied as a coating layer in a multi-layer film build.

The coatings according to the invention may be applied in a dry film thickness in a range of, e.g., 30 to 200 μm for each coating layer, as a primer layer, a base coat layer, a clear coat or a top coat layer.

The term dry film thickness stated in the present description is known in the art.

Suitable powder coating compositions comprise at least one binder resin and, optionally at least one curing agent, and optionally, at least one pigment and/or extender and/or coating additive. The amount of those component(s) is depending on the final powder coating composition. The content of the at least one binder resin can be in a range between 50 and 100 parts per weight, preferably, between 60 and 97 parts per weight, the parts per weight based on binder resin and curing agent, depending on the cross-linking chemistry of the binder resin and curing agent.

Conventional binder resins and curing agents known to a person skilled in the art may be used.

Examples of binder resins are polyester resins, urethane resins, polyester urethane resins, polyester epoxy resins, epoxy resins, (meth) acrylic resins, alkyd resins and melamine/urea/formaldehyde resins. Suitable polyester resins may be either acid or hydroxyl functional, depending on the cross-linking chemistry used. For example, hydroxyl functional polyester resins may have a hydroxyl number in the range of, for example, 30 to 350 mg KOH/g resin, and carboxyl functional polyester resin may have an acid number in the range of, for example, 10 to 200 mg KOH/g resin. The polyesters may be produced in a conventional manner by reacting of one or more aliphatic, aromatic or cycloaliphatic di- or polycarboxylic acids, and the anhydrides and/or esters thereof with polyalcohols, as is, for example, described in D. A. Bates, The Science of Powder Coatings, volumes 1 & 2, Gardiner House, London, 1990, and as known by the person skilled in the art.

The term hydroxyl number in this document is defined as the number of mg of potassium hydroxide (KOH) which is equal to the number of mg acetic acid for acetalizing of 1 g of the resin, determined according to DIN 53240.

The term acid number in this document is defined as the mg of potassium hydroxide required to neutralise the acid groups of the polyester, described in DIN EN ISO 2114.

Suitable (meth)acrylic resins include, for example, copolymers prepared from alkyl(meth) acrylates with glycidyl(meth) acrylates and olefinic monomers; functionalized resins such as polyester (meth) acrylates, epoxy (meth) acrylates, urethane (meth) acrylates, glycidyl(meth) acrylates.

The term (meth) acrylic is respectively intended to mean acrylic and/or methacrylic.

Crystalline and/or semi-crystalline binder resins are also usable which have a Tm in the range of 50 to 200° C.

Preferred binder resin is polyester resin, polyester urethane resin, polyester epoxy resins and/or (meth) acrylic resin. Particularly preferred binder resin is polyester resin and/or (meth) acrylic resin.

The binder resins may comprise self cross-linkable resins containing cross-linkable functional groups known by a person skilled in the art. In this case, no curing agent needs to be used in the composition according to the invention.

The at least one curing agent (cross-linker) suitable for cross-linking with the binder resins are known by a person skilled in the art. Examples of curing agents are blocked cycloaliphatic, aliphatic or aromatic polyisocyanates; agents containing epoxy groups, such as, for example, triglycidyl isocyanurate (TGIC); polyglycidyl ethers based on diethylene glycol; glycidyl functionalized (meth) acrylic copolymers; agents containing amino, amido, (meth)acrylate and/or hydroxyl groups, for example hydroxyl alkylamide crosslinker, as well as vinyl ethers. Furthermore, conventionally curing agents such as, dicyanodiamide hardeners, carboxylic acid hardeners or phenolic hardeners are usable.

Examples of pigments are colour-imparting and/or special effect-imparting pigments and/or fillers (extenders). Suitable colour-imparting pigments are any conventional coating pigments of an organic or inorganic nature considering their heat stability which must be sufficient to withstand the curing conditions of the powder coating composition of the invention. Examples of inorganic or organic colour-imparting pigments are titanium dioxide, micronized titanium dioxide, carbon black, iron oxide, azo pigments, and phthalocyanine pigments. Examples of special effect-imparting pigments are metal pigments, for example, made from aluminium, copper or other metals, interference pigments, such as, metal oxide coated metal pigments and coated mica. Examples of usable extenders are silicon dioxide, aluminium silicate, barium sulfate, calcium carbonate, magnesium carbonate and micronized dolomite. The pigments and/or extenders can be used in conventional amounts known to the person skilled in the art, for example, 0.1 to 40 weight %, based on the total weight of the final powder coating composition.

Common coating additives are agents known to a person skilled in the art. Examples are levelling agents, rheological agents such as highly dispersed silica or polymeric urea compounds, thickeners, for example, based on partially cross-linked, carboxy-functional polymers or on polyurethanes, defoamers, wetting agents, anticratering agents, degassing agents, thermolabile initiators, antioxidants and light stabilizers based on HALS (hindered amine light stabilizer) products, tribo-charging agents, accelerators, initiators, inhibitors and catalysts. The coating additives can be used in conventional amounts known to the person skilled in the art, for example, 0.01 to 10 weight %, based on the total weight of the final powder coating composition.

The powder coating compositions may contain also at least one unsaturated resin which can be crosslinked by free-radical polymerization, and, optionally, photo-initiators, for example, kind and amount as known in the art. These powder coating resins can be prepolymers, such as, polymers and oligomers, containing, per molecule, one or more, free-radically polymerizable olefinic double bonds.

The powder coating compositions are prepared by conventional manufacturing techniques used in the powder coating industry and known to the skilled person. For example, the ingredients used in the powder coating composition, can be blended together and heated to a temperature to melt the mixture and then the mixture is extruded. The extruded material is then cooled on chilled rollers, broken up and then ground to a fine powder, which can be classified to the desired grain size.

The average particle size is in the range of 1 to 300 μm, preferably of 20 to 200 μm.

The term average particle size mentioned in this document is based on the D90 value based on the standards mentioned below. The D90 value corresponds to a particle size below which 90 weight % of the particles lie, wherein the particle size analysis is done by a laser diffraction method and meets the standards set forth in ISO 13320-1. Measurements is done on a Malvern Mastersizer 2000.

Specific components of the powder coating composition, for example, coating additives, pigments, extenders, may be processed with the finished powder coating particles after extrusion and grinding by a “bonding” process using an impact fusion. For this purpose, the specific components may be mixed with the individual powder coating particles. During blending, the individual powder coating particles are treated to softening their surface so that the components adhere to them and are homogeneously bonded with the surface of the powder coating particles. The softening of the powder particles' surface may be done by heat treating the particles to a temperature, e.g. in the range of 40 to 100° C., dependent from the melt behaviour of the powder particles. After cooling the desired particle size of the resulted particles may be achieved by a sieving or classifying process.

In certain applications, the substrate to be coated may be pre- heated before the application of the powder, and then either heated after the application of the powder or not. For example, gas is commonly used for various heating steps, but other methods, e.g., microwaves, IR or NIR are also known. Also a primer can be applied, which seals the surface and provides the required electrical conductivity. UV-curable primers are also available.

Substrates, which may be considered, are metal, wooden substrates, wood fiber material, paper or plastic parts, for example, also fiber re-inforced plastic parts, for example, automotive and industrial bodies or body parts, for example, wheels, casing for lamps.

The present invention is further defined in the following Examples. It should be understood that these Examples are given by way of illustration only. All parts and percentages are on a weight basis unless otherwise indicated.

### EXAMPLES

### Example 1

### Preparation of a Powder Coating Composition of Prior Art

After mixing the components of a powder coating composition comprising a polyester resin as binder resin in the mixer, the coating composition was processed further by extrusion with a twin screw extruder at a temperature setting of the extruder of 110 to 120° C. After extruding, the molten composition was cooled down on a cooling belt and the resulted product was correspondingly crushed to small chips. Afterwards, the chips were milled and sieved to an applicable particle size distribution typical for the electrostatic spraying in a range of 10 to 120 μm.

### Example 2

### Application and Curing according to Prior Art

The powder of Example 1 was sprayed onto a metal plate coated with black cationic electro-deposition primer, with an electrostatic spray gun to a film thickness of 80 μm.

The plate with the applied powder on its surface was heated using the combination of IR and convection heat at a temperature of 120° C. for 10 min, to melt the powder. Afterwards, the hot metal plate with the molten powder was heated using the combination of IR and convection heat at a temperature of 140 to 150° C. for 20 to 25 min, to cure the molten powder.

### Example 3

### Application and Curing according to the Invention

The application and curing of the powder of Example 1 was done at the same conditions as used in Example 2 but including the vibrating step as follows: After applying the powder on the surface of the plate the vibrating step was done using a vibration device, which was fixed on the application device, with a vibration power of 5 KN and a frequency of the vibrations of 80 Hz for 30 seconds. By starting the melting of the powder the vibration power was increased to 8 KN and the frequency of the vibrations to 150 Hz for 20 seconds. The plate with the applied powder was then heated by IR and convection heat at a temperature of 140 to 150° C. for 20 to 25 min, to cure the molten powder.

### Example 4

### Testing of the Resulted Cured Coatings

TABLE 1

| | | Uniform | Flow |
|---|---|---|---|
| | Thickness | Distribution | Behavior |
| | Performance | (Packing Density | (Wave Scan |
| Examples | (*) | of the Powder) | LW/SW) |
| Example 2 | 80 +/− 8 μm | 44% | 25/13 |
| Example 3 | 80 +/− 3 μm | 52% | 21/11 |

(*) measured in accordance with DIN EN ISO 2178

The Flow Behavior was measured by Wave Scan measurement as known in the art using Wave Scan DOI (distinctness of image) of company Byk-Gardner (Germany), the measurement is based on the modulation of laser light reflected from the surface of the coated substrate. The parameters of longwave LW (about 1-10 mm) and shortwave SL (about 0.3-1 mm) were measured. Low results correspond to smoother flow.

As it can be seen from the test results of Table 1 the example regarding the invention provides increased thickness performance, uniform distribution and higher flow behavior providing a smoother coating surface.

1. A powder coating method comprising the following steps:
a) applying particles of a powder coating composition the particles having a number average particle size in the range of 1 to 300 μm onto a substrate surface, wherein the number average particle size is based on D90 value determined according to ISO 13320-1 ,
b) vibrating the particles on the substrate surface at near-ambient temperature or increased temperature with at least one vibrator device providing a frequency of the vibrations in a range of 10 to 1000 Hz and a given vibration power, during and/or after the applying, and
c) processing the vibrated particles to a cured coating on the substrate surface.

2. The method according to claim 1 wherein the frequency of the vibrations in step b) is in a range of 10 to 100 Hz.

3. The method according to claims 1 wherein the given vibration power in step b) is in the range of 0.5 KN (Kilo Newton) to 60 KN.

4. The method according to claim 1 wherein the vibrating step b) is proceeded in a time period of 5 to 100 seconds.

5. The method according to claim 1 wherein the powder coating composition comprises at least one binder resin which is a polyester resin and/or (meth) acrylic resin.

6. A coated substrate coated with the powder coating method of claim 1.
